(19) United States
(12) Patent Application Publication
(10) Pub. No.: US 2026/0216932 A1
(43) Pub. Date: Jul. 30, 2026

(54) Molding Material, Method For Producing Molding Material, Molded Article, And Method For Producing Molded Article

(71) Applicant: SEIKO EPSON CORPORATION, Tokyo (JP)

(72) Inventors: Masaaki AOTA, Suwa (JP); Tomohiro FUJITA, Matsumoto (JP)

(21) Appl. No.: 19/462,277

(22) Filed: Jan. 28, 2026

(30) Foreign Application Priority Data
Jan. 29, 2025 (JP) 2025-013284

(51) Int. Cl. B29C 45/00; B29B 7/82; B29K 21/00; B29K 105/00; B29K 201/00; B29K 475/00

(52) U.S. Cl. CPC B29C 45/0001; B29B 7/82; B29C 45/0005; B29C 45/0013; B29K 2021/003; B29K 2105/251; B29K 2201/00; B29K 2475/00

(57) ABSTRACT

The molding material of the present disclosure contains organic fibers that do not melt at 200° C., a thermoplastic resin that melts at 200° C. or lower, and thermosetting polyurethane particles. The content of the thermosetting polyurethane particles in the molding material is preferably 10.0% by mass or more and 40.0% by mass or less. The content of the thermoplastic resin in the molding material is preferably 20.0% by mass or more and 75.0% by mass or less.

The present application is based on, and claims priority from JP Application Serial Number 2025-013284, filed Jan. 29, 2025, the disclosure of which is hereby incorporated by reference herein in its entirety.

### BACKGROUND

### 1. Technical Field

The present disclosure relates to a molding material, a method for producing a molding material, a molded article, and a method for producing a molded article.

### 2. Related Art

In recent years, by recycling various plastic materials such as polyester, social movement for effective use of resources, reduction of waste, and saving of waste has been progressing.

JP-A-2004-025857 discloses a wood substitute material for packaging that is obtained by heating and compressing a fiber mass formed of 100 parts by mass of collected fibers and 30 to 50 parts by mass of thermoplastic resin fibers having a melting point lower than the temperature at which the collected fibers deteriorate that are entangled with each other, at a temperature higher than the melting point of the thermoplastic resin fibers but at which the collected fibers do not deteriorate, and has a density of 0.4 to 0.7 g/cm³.

Incidentally, polyurethane has characteristics such as excellent stretchability and flexibility, and is used in various products such as elastic members such as sponge and rubber, and clothes.

However, since polyurethane generates toxic gases (an amine group-containing compound and the like) or odors by thermal decomposition, it is difficult to recycle polyurethane. JP-A-2004-025857 discloses compression molding, but in the case of using collected fibers containing polyurethane, a molded article having sufficiently high mechanical strength cannot be obtained. Further, the technology described in JP-A-2004-025857 does not enable injection molding when collected fibers containing polyurethane are used, and has a low degree of freedom in molding.

### SUMMARY

The present disclosure has been made to solve the above problems and can be implemented as the following application example.

A molding material according to an application example of the present disclosure contains organic fibers that do not melt at 200° C., a thermoplastic resin that melts at 200° C. or lower; and thermosetting polyurethane particles.

A method for producing a molding material according to an application example of the present disclosure includes a heating and kneading step of kneading organic fibers that do not melt at 200° C., a thermoplastic resin that melts at 200° C. or lower, and thermosetting polyurethane particles while heating such that the thermoplastic resin melts and the thermosetting polyurethane particles do not melt.

A molded article according to an application example of the present disclosure contains the molding material according to the application example of the present disclosure.

A method for producing a molded article according to an application example of the present disclosure includes a molding step of molding the molding material according to the application example of the present disclosure while heating to a temperature at which the thermoplastic resin melts and the thermosetting polyurethane particles do not melt.

A method for producing a molded article according to another application example of the present disclosure includes a heating and kneading step of kneading organic fibers that do not melt at 200° C., a thermoplastic resin that melts at 200° C. or lower, and thermosetting polyurethane particles while heating such that the thermoplastic resin melts and the thermosetting polyurethane particles do not melt to obtain a molding material containing the organic fibers, the thermoplastic resin, and the thermosetting polyurethane particles, and a molding step of molding the molding material while heating to a temperature at which the thermoplastic resin melts and the thermosetting polyurethane particles do not melt, wherein a content of the thermosetting polyurethane particles in the molding material is 10.0% by mass or more and 40.0% by mass or less, a content of the thermoplastic resin in the molding material is 20.0% by mass or more and 75.0% by mass or less, a content of the organic fibers in the molding material is 10.0% by mass or more and 55.0% by mass or less, the organic fibers are at least one kind selected from the group consisting of cellulose fibers and fibers made of a thermoplastic resin, the organic fibers are a defibrated product of a fabric, a heating temperature in the heating and kneading step is 150° C. or higher and 200° C. or lower, and a heating temperature in the molding step is 160° C. or higher and 200° C. or lower.

### BRIEF DESCRIPTION OF THE DRAWINGS

FIG. 1 is a table collectively showing the compositions of molding materials and evaluation results for Examples and Comparative Examples.

FIG. 2 is a photograph showing an image obtained by performing transmitted illumination observation using a digital microscope for a sample obtained by slicing a molded article used for evaluation of Charpy impact strength of Comparative Example 3 into a thickness of 100 μm.

### DESCRIPTION OF EMBODIMENTS

Hereinafter, preferred embodiments of the present disclosure will be described in detail.

### [1] Molding Material

First, a molding material of the present disclosure will be described.

The molding material of the present disclosure contains organic fibers that do not melt at 200° C., a thermoplastic resin that melts at 200° C. or lower, and thermosetting polyurethane particles.

Such a configuration can provide a molding material that contains polyurethane, can be injection molded, and has a high degree of freedom in molding. In addition, it is possible to provide a molding material that can be suitably used for the production of a molded article having excellent mechanical strength, particularly both impact strength and bending strength. In addition, the bending modulus of a molded article produced using the molding material can also be made excellent. In addition, since the moldability of the molded article can be made more excellent, the productivity of the molded article can also be improved. In particular, by containing a resin that melts at 200° C. or lower, the molding material can be suitably molded at a temperature at which the thermal decomposition of the polyurethane is sufficiently prevented. Further, although polyurethane is contained in a large amount in waste products and the like of elastic members such as sponge and rubber, and clothes, it has been difficult to recycle and to incinerate polyurethane because toxic gases are generated by thermal decomposition, but according to the present disclosure, such polyurethane can be suitably reused.

On the other hand, when the above conditions are not satisfied, no satisfactory result can be obtained.

For example, even when the molding material contains the thermoplastic resin that melts at 200° C. or lower and the thermosetting polyurethane particles, if the molding material does not contain the organic fibers that do not melt at 200° C., the elastic modulus and the shape retainability of the molded article produced using the molding material are remarkably low.

For example, when inorganic fibers such as carbon fibers (PAN-based carbon fibers or the like) are contained instead of the organic fibers that do not melt at 200° C., an affinity for the thermoplastic resin that melts at 200° C. or lower or the thermosetting polyurethane particles decreases, and the mechanical strength of the molded article produced using the molding material decreases.

Even when the molding material contains the organic fibers that do not melt at 200° C. and the thermoplastic resin that melts at 200° C. or lower, if the molding material does not contain the thermosetting polyurethane particles, there arises a problem in that the impact strength of the molded article produced using the molding material decreases.

Even when the molding material contains the organic fibers that do not melt at 200° C. and the thermosetting polyurethane particles, if the molding material does not contain the thermoplastic resin that melts at 200° C. or lower, the moldability of the molded article significantly decreases, in which injection molding cannot be performed, for example. Further, due to the decrease in moldability, the mechanical strength of the produced molded article also deteriorates.

When the molding material contains a thermoplastic resin having a melting point of higher than 200° C. instead of the thermoplastic resin that melts at 200° C. or lower, the degree of freedom in molding cannot be sufficiently increased, and injection molding cannot be performed, for example. Further, the molded article produced using such a molding material is inferior in mechanical strength.

Even when the molding material contains the organic fibers that do not melt at 200° C., the thermoplastic resin that melts at 200° C. or lower, and a thermosetting polyurethane, if the thermosetting polyurethane does not form a particulate shape, the mechanical strength of the molded article produced using the molding material cannot be made sufficiently excellent.

### [1-1] Organic Fibers That do not Melt at 200° C.

The molding material of the present disclosure contains organic fibers that do not melt at 200° C.

The organic fibers that do not melt at 200° C. are a component that greatly contributes to the retention of the shape of the molded article produced using the molding material of the present disclosure, and also greatly affects the properties such as strength of the molded article.

Examples of the organic fibers that do not melt at 200° C. include cellulose fibers, fibers made of a thermoplastic resin, and fibers made of a thermosetting resin. The organic fibers are preferably at least one kind selected from the group consisting of cellulose fibers and fibers made of a thermoplastic resin, and it is more preferable to use cellulose fibers and fibers made of a thermoplastic resin in combination. This can make the mechanical strength of the molded article produced using the molding material even more excellent.

When the organic fibers that do not melt at 200° C. include the cellulose fibers and the fibers made of a thermoplastic resin, the following conditions are preferably satisfied when the proportion of the cellulose fibers and the proportion of the fibers made of a thermoplastic resin to the entire organic fibers that do not melt at 200° C. are XC [% by mass] and XT [% by mass], respectively. That is, the relation 0.50≤XC/XT≤2.00 is preferably satisfied, the relation 0.67≤XC/XT≤1.50 is more preferably satisfied, and the relation 0.75≤XC/XT≤1.35 is even more preferably satisfied. This can make the impact strength and the bending strength of the molded article produced using the molding material more excellent.

Cellulose is an abundant natural material derived from plants. Therefore, the use of the cellulose fibers as the organic fibers that do not melt at 200° C. can suitably cope with environmental problems, saving of buried resources, and the like, and is also preferable from the viewpoint of stable supply of the molding material and the molded article produced using the same, cost reduction, and the like. In addition, the cellulose fibers have a particularly high theoretical strength among various fibers, and are advantageous from the viewpoint of improving the strength of the molded article.

As the cellulose fibers, virgin pulp may be used, or wastepaper, waste cloth, or the like may be reused. The cellulose fibers are usually mainly formed of cellulose, but may contain components other than cellulose. Examples of such components include hemicellulose and lignin. As the cellulose fibers, those subjected to treatment such as bleaching may be used.

Examples of the cellulose fibers include a pulp-defibrated product, cotton, hemp, rayon, and cupra. As the pulp-defibrated product, for example, cotton-like defibrated products obtained by defibrating wastepaper or the like, that is, pulp-defibrated cotton or the like can be suitably used.

By using the fibers made of a thermoplastic resin as the organic fibers that do not melt at 200° C., for example, fibers constituting waste clothes or the like can be suitably used as the organic fibers that do not melt at 200° C., and the ratio of waste utilization can be increased, which is particularly preferable from the viewpoint of reduction of environmental load, effective utilization of resources, and the like.

Examples of the thermoplastic resin constituting the fibers made of a thermoplastic resin include a polyester resin, an acrylic-based resin, nylon, and an acetate resin. Among these, a polyester resin and an acrylic-based resin are preferable. This can make the affinity of the organic fibers that do not melt at 200° C. for the thermoplastic resin that melts at 200° C. or lower or the thermosetting polyurethane particles more suitable, and make the mechanical strength of the molded article produced using the molding material more excellent. In addition, since these fibers are widely used as fibers constituting clothes and the like, by using these fibers as the organic fibers that do not melt at 200° C., the ratio of utilization of waste clothes can be suitably increased, which is particularly preferable from the viewpoint of reduction of environmental load, effective utilization of resources, and the like.

As the organic fibers that do not melt at 200° C., a defibrated product of a fabric is preferably used. This can relatively easily reuse fabric generated in a large amount as waste clothes or the like. Note that woven fabrics of carbon fibers or glass fibers are usually broken at the time of defibration, and thus do not contribute to improvement in mechanical strength. Woven fabrics of carbon fibers or glass fibers are mainly used as constituent materials of fiber-reinforced plastics, and a large amount of energy is required for taking out the carbon fibers or glass fibers from the materials, and defibrating and reusing the carbon fibers or glass fibers. Also from the above, it is not appropriate to use inorganic fibers instead of the organic fibers that do not melt at 200° C.

The average length of the organic fibers that do not melt at 200° C. is not particularly limited, but is preferably 50 μm or more and less than 3 mm, more preferably 70 μm or more and less than 2,000 μm, and even more preferably 100 μm or more and less than 1,500 μm. This can make the stability of the shape, strength, and the like of the molded article produced using the molding material more excellent. In addition, it is possible to more effectively prevent or inhibit the generation of dust in the molded article produced using the molding material. In addition, it is possible to more effectively prevent the occurrence of unintentional unevenness on the surface of the molded article produced using the molding material. Note that the fiber length is determined by a method conforming to ISO 16065-2:2007.

The average diameter of the organic fibers that do not melt at 200° C. is not particularly limited, but is preferably 3 μm or more and less than 100 μm, more preferably 4 μm or more and less than 50 μm, and even more preferably 5 μm or more and less than 20 μm. This can make the stability of the shape, strength, and the like of the molded article produced using the molding material more excellent. In addition, it is possible to more effectively prevent the occurrence of unintentional unevenness on the surface of the molded article produced using the molding material.

The average aspect ratio, that is, the ratio of the average length to the average diameter of the organic fibers that do not melt at 200° C. is not particularly limited, but is preferably 10 or more and 1,000 or less, and more preferably 15 or more and 100 or less. This can make the stability of the shape, strength, and the like of the molded article produced using the molding material more excellent. In addition, it is possible to more effectively prevent or inhibit the generation of dust in the molded article produced using the molding material. In addition, it is possible to more effectively prevent the occurrence of unintentional unevenness on the surface of the molded article produced using the molding material.

The content of the organic fibers that do not melt at 200° C. in the molding material of the present disclosure is preferably 10.0% by mass or more and 55.0% by mass or less, more preferably 15.0% by mass or more and 50.0% by mass or less, and even more preferably 20.0% by mass or more and 45.0% by mass or less. This can achieve both the moldability of the molding material and the mechanical strength (in particular, impact strength, bending strength, and bending modulus) of the molded article produced using the molding material at a higher level.

### [1-2] Thermoplastic Resin That Melts at 200° C. or Lower

The molding material of the present disclosure contains a thermoplastic resin that melts at 200° C. or lower, that is, a thermoplastic resin having a melting point of 200° C. or lower.

By containing the thermoplastic resin that melts at 200° C. or lower, the toughness of the molded article produced using the molding material of the present disclosure can be increased, and the impact resistance of the molded article can be made sufficiently excellent.

The melting point of the thermoplastic resin that melts at 200° C. or lower is only required to be 200° C. or lower, but is preferably 115° C. or higher and 185° C. or lower, and more preferably 145° C. or higher and 180° C. or lower.

Examples of the thermoplastic resin that melts at 200° C. or lower include polyolefins such as polyethylene and polypropylene, and polyesters such as aliphatic polyesters (polylactic acid, polybutylene succinate, and the like), and aromatic polyesters, and one kind or a combination of two or more kinds selected from these can be used, but at least one kind selected from the group consisting of polypropylene and polylactic acid is preferable. In particular, by using a thermoplastic resin derived from a biomass raw material (polylactic acid or the like), the consumption of buried resources can be more suitably reduced.

In the present disclosure, when recycled polypropylene is used also, excellent effects as described above can be obtained. More specifically, in general, recycled polypropylene has a problem in that the molecular weight decreases due to thermal decomposition during recycling, the viscosity decreases, and the moldability also decreases. However, in the present disclosure, excellent injection moldability can be secured even when recycled polypropylene is used.

The aliphatic polyester is a polyester that does not have an aromatic chemical structure, and is a polyester in which all constituent monomers do not have an aromatic chemical structure. Examples of the aliphatic polyester include ones in which both a polycarboxylic acid component and a polyhydric alcohol component as constituent monomers have an aliphatic alkylene group. Further, the aliphatic polyester may be formed of a monomer having a hydroxy group and a carboxy group in the molecule. Examples of the aliphatic polyester formed of a monomer having a hydroxy group and a carboxy group in the molecule include polylactic acid.

When the aliphatic polyester has a chemical structure in which a polycarboxylic acid component having an aliphatic alkylene group and a polyhydric alcohol component having an aliphatic alkylene group are polymerized, the aliphatic polyester preferably has a chemical structure in which an alkylene dicarboxylic acid having an alkylene group with a carbon chain length of 2 or more and 6 or less and an alkylene diol having an alkylene group with a carbon chain length of 2 or more and 8 or less are condensed. This allows the above-described effects to be more significantly exhibited.

The carbon chain length of the alkylene group of the alkylene dicarboxylic acid is preferably 2 or more and 6 or less, more preferably 2 or more and 5 or less, and even more preferably 2 or more and 4 or less. This allows the above-described effects to be more significantly exhibited.

The alkylene group of the alkylene dicarboxylic acid may have a branched structure, but is preferably a linear structure. This allows the above-described effects to be more significantly exhibited.

Examples of the alkylene dicarboxylic acid include succinic acid, glutaric acid, adipic acid, pimelic acid, suberic acid, azelaic acid, and sebacic acid, and one kind or a combination of two or more kinds selected from these can be used.

The carbon chain length of the alkylene group of the alkylene diol is preferably 2 or more and 8 or less, more preferably 2 or more and 6 or less, and even more preferably 3 or more and 5 or less. This allows the above-described effects to be more significantly exhibited.

The alkylene group of the alkylene diol may have a branched structure, but is preferably a linear structure. This allows the above-described effects to be more significantly exhibited.

Examples of the alkylene diol include 1,2-ethanediol, 1,3-propanediol, 1,4-butanediol, 1,5-pentanediol, 1,6-hexanediol, 1,7-heptanediol, and 1,8-octanediol, and one kind or a combination of two or more selected from these can be used.

Specific examples of the aliphatic polyester containing the alkylene dicarboxylic acid and the alkylene diol satisfying the above conditions as monomer components include polybutylene succinate, polybutylene succinate adipate, and polyethylene adipate, and one kind or a combination of two or more kinds selected from these can be used.

These are materials having biodegradability, and can more suitably reduce environmental load by the molded article. In addition, these materials are relatively inexpensive, and easily stably available. Therefore, it is advantageous also from the viewpoint of stable supply of the molding material and the molded article, cost reduction, and the like.

The content of the thermoplastic resin that melts at 200° C. or lower in the molding material of the present disclosure is not particularly limited, but is preferably 20.0% by mass or more and 75.0% by mass or less. This can achieve both the moldability of the molding material and the mechanical strength (in particular, impact strength, bending strength, and bending modulus) of the molded article produced using the molding material at a higher level.

When the content of the thermoplastic resin that melts at 200° C. or lower and the content of the organic fibers that do not melt at 200° C. in the molding material of the present disclosure are XR [% by mass] and XO [% by mass], respectively, the relation 0.03≤XO/XR≤3.0 is preferably satisfied, the relation 0.10≤XO/XR≤2.8 is more preferably satisfied, and the relation 0.50≤XO/XR≤2.5 is even more preferably satisfied. This can make the impact strength and the bending strength of the molded article produced using the molding material more excellent.

### [1-3] Thermosetting Polyurethane Particles

The molding material of the present disclosure contains thermosetting polyurethane particles. The thermosetting polyurethane particles function as a filler in the molded article.

The thermosetting polyurethane particles are particles mainly formed of a thermosetting polyurethane in a cured state. The thermosetting polyurethane particles may contain components other than the thermosetting polyurethane, but the content of the thermosetting polyurethane in the thermosetting polyurethane particles is preferably 90% by mass or more, more preferably 95% by mass or more, and even more preferably 99% by mass or more.

The thermosetting polyurethane constituting the thermosetting polyurethane particles is usually a component having excellent affinity for both the organic fibers that do not melt at 200° C. and the thermoplastic resin that melts at 200° C. or lower.

As the thermosetting polyurethane particles, for example, thermosetting urethane foam, thermosetting urethane rubber, or the like can be used, and crushed materials of these can be used, for example.

The number average molecular weight of the thermosetting polyurethane is preferably 20,000 or more and 300,000 or less, more preferably 30,000 or more and 200,000 or less, and even more preferably 40,000 or more and 150,000 or less. This can make the affinity of the thermosetting polyurethane particles for the organic fibers that do not melt at 200° C. and/or the thermoplastic resin that melts at 200° C. or lower more suitable, and make the impact strength and the bending strength of the molded article produced using the molding material more excellent.

The average particle size of the thermosetting polyurethane particles is not particularly limited, but is preferably 2.0 mm or less, more preferably 1.0 μm or more and 1,500 μm or less, and even more preferably 50 μm or more and 150 μm or less. This can make the mechanical strength of the molded article produced using the molding material more excellent. Note that in the present specification, the average particle size refers to a volume-based average particle size.

The content of the thermosetting polyurethane particles in the molding material of the present disclosure is preferably 10.0% by mass or more and 40.0% by mass or less. This can achieve both the moldability of the molding material and the mechanical strength (in particular, impact strength, bending strength, and bending modulus) of the molded article produced using the molding material at a higher level.

The sum of the content of the thermoplastic resin that melts at 200° C. or lower and the content of the thermosetting polyurethane particles in the molding material of the present disclosure is preferably 30.0% by mass or more and 90.0% by mass or less. This can achieve both the moldability of the molding material and the mechanical strength (in particular, impact strength, bending strength, and bending modulus) of the molded article produced using the molding material at a higher level.

When the content of the thermoplastic resin that melts at 200° C. or lower and the content of the thermosetting polyurethane particles in the molding material of the present disclosure are XR [% by mass] and XU [% by mass], respectively, the relation 0.01≤XU/XR≤0.30 is preferably satisfied, the relation 0.02≤XU/XR≤0.27 is more preferably satisfied, and the relation 0.03≤XU/XR≤0.25 is even more preferably satisfied. This can achieve both the moldability of the molding material and the mechanical strength (in particular, impact strength, bending strength, and bending modulus) of the molded article produced using the molding material at a higher level.

When the content of the organic fibers that do not melt at 200° C. and the content of the thermosetting polyurethane particles in the molding material of the present disclosure are XO [% by mass] and XU [% by mass], respectively, the relation 0.01≤XU/XO≤3.0 is preferably satisfied, the relation 0.05≤XU/XO≤2.3 is more preferably satisfied, and the relation 0.10≤XU/XO≤1.8 is even more preferably satisfied. This can achieve both the moldability of the molding material and the mechanical strength (in particular, impact strength, bending strength, and bending modulus) of the molded article produced using the molding material at a higher level.

### [1-4] Flame Retardant

The molding material of the present disclosure may further contain a flame retardant.

Examples of the flame retardant include inorganic flame retardants such as antimony compounds, metal hydroxides, nitrogen compounds, and boron compounds; and organic flame retardants such as bromine compounds and phosphorus compounds.

When the molding material contains the flame retardant, the content of the flame retardant can be 1.0 part by mass or more and 20.0 parts by mass or less when the total content of the organic fibers that do not melt at 200° C., the thermoplastic resin that melts at 200° C. or lower, and the thermosetting polyurethane particles is 100.0 parts by mass. This can make the flame retardancy of the molded article produced using the molding material of the present disclosure more excellent while more effectively exhibiting the above-described effects by the present disclosure.

### [1-5] Other Components

The molding material of the present disclosure may contain components other than those described above. Hereinafter, such components are also referred to as “other components” in this section. Examples of the other components include colorants, insect repellents, antifungal agents, antioxidants, ultraviolet absorbents, aggregation inhibitors, release agents, and resin materials other than those described above. However, the content of the other components in the molding material of the present disclosure is preferably 10.0% by mass or less, more preferably 5.0% by mass or less, and even more preferably 3.0% by mass or less.

### [2] Method for Producing Molding Material

Next, a method for producing a molding material of the present disclosure will be described.

The method for producing a molding material of the present disclosure includes a heating and kneading step of kneading organic fibers that do not melt at 200° C., a thermoplastic resin that melts at 200° C. or lower, and thermosetting polyurethane particles while heating such that the thermoplastic resin (that is the thermoplastic resin that melts at 200° C. or lower) melts and the thermosetting polyurethane particles do not melt. Such a configuration can efficiently produce the molding material of the present disclosure as described above.

In the heating and kneading step, for example, a uniaxial kneader or a biaxial kneader can be used.

The heating temperature in the heating and kneading step is preferably 150° C. or higher and 200° C. or lower, more preferably 160° C. or higher and 195° C. or lower, and even more preferably 170° C. or higher and 190° C. or lower. This can make the moldability of the obtained molding material more excellent. In addition, the adhesion among the organic fiber that does not melt at 200° C., the thermoplastic resin that melts at 200° C. or lower, and the thermosetting polyurethane particles can be made more excellent, and the mechanical strength of the molded article produced using the molding material can be made more excellent.

The strand-shaped molding material obtained by kneading may be pelletized using a pelletizer of, for example, a strand system or a water ring hot cut system to obtain a pellet-shaped molding material.

The following method may also be applied as the method for producing a molding material. That is, the kneaded product of the above-described components may be molded into a sheet shape, and then cut into a desired shape by using, for example, a shredder device to obtain a pellet-shaped molding material. The method for forming the kneaded product into a sheet shape is not particularly limited, and examples thereof include a method of first accumulating the kneaded product in the air to form a sheet-shaped accumulation, compressing the accumulation in a calender to eliminate air and increase density, then heating the accumulation in a non-contact manner using a heating furnace, and then heating and pressing the accumulation with a heat press apparatus. The shape and size of the pellet obtained by cutting are not particularly limited. For example, the pellet can be a substantially rectangular parallelepiped having a length of a side of 2 mm or more and 5 mm or less.

The organic fibers that do not melt at 200° C. used in the production of the molding material of the present disclosure may be ones that have been subjected to defibration treatment in advance. In particular, an organic fiber source containing organic fibers, such as wastepaper and waste cloth, may be defibrated and used.

The fiber source as described above may be coarsely crushed before being defibrated. The coarse crushing of the fiber source can be performed by, for example, shredding the fiber source into small pieces using a shredder having a coarsely crushing blade in an atmosphere such as the air. The form of the small piece is, for example, a substantially cubic shape or a substantially rectangular parallelepiped shape a few millimeters square. The small pieces of the fiber source are defibrated into untangled fibers. Being defibrated referred to here refers to untangling a state in which a plurality of fibers are integrated into each single fiber.

The defibration can be suitably performed under dry conditions. Dry referred to here refers to not being performed in liquid but being performed in gas such as the air. Note that for the purpose of preventing electrification or the like, for example, water or the like may be sprayed onto the fibers. Dry defibration can be suitably performed with, for example, an air current.

The defibration of the fiber source may be performed separately for each fiber source or may be performed in a state in which a plurality of kinds of fiber sources are mixed.

A fiber source containing a plurality of kinds of fibers may be used. Examples of the fiber source containing two or more kinds of fibers include a blended product.

The defibration of the fiber source may be performed in a state in which components other than the fibers, for example, a thermoplastic resin that melts at 200° C. or lower, thermosetting polyurethane particles, a flame retardant, other components, and the like are contained.

### [3] Molded Article

Next, a molded article of the present disclosure will be described.

The molded article of the present disclosure is formed of the molding material of the present disclosure described above. Such a configuration can provide a molded article that contains polyurethane and has excellent mechanical strength, particularly, both impact strength and bending strength. In addition, the bending modulus of the molded article can also be made excellent. Further, although polyurethane is contained in a large amount in waste products and the like of elastic members such as sponge and rubber, and clothes, it has been difficult to recycle and to incinerate polyurethane because it generates toxic gases during thermal processing, but according to the present disclosure, such polyurethane can be suitably reused.

Note that the molded article of the present disclosure is only required to have a portion formed of the molding material of the present disclosure described above, and may have a portion formed of a material other than the molding material of the present disclosure.

Each component constituting the molded article preferably satisfies the conditions described in [1-1] to [1-5] above.

The shape of the molded article is not particularly limited, and may be any shape such as a sheet shape, a block shape, a spherical shape, or a three-dimensional shape.

The molded article may have any uses, but can be suitably applied to those used in an environment in which dust generation or the like is problematic, more specifically, for example, members having a flow path of a fluid, members disposed around the members, ink cartridges, various containers, various fixtures, and the like. Former molded articles produced using materials containing a fiber material and a resin have a problem in that they are apt to generate dust and have a problem in that they are not suitable for use in an environment in which dust generation or the like is problematic as described above. In contrast, the molded article according to the present disclosure is less likely to generate dust. Therefore, when applied to the above uses, the effects of the present disclosure are more significantly exhibited.

### [4] Method for Producing Molded Article

Next, a method for producing a molded article of the present disclosure will be described.

The method for producing a molded article of the present disclosure includes a molding step of molding the above-described molding material of the present disclosure while heating to a temperature at which the thermoplastic resin (that is, the thermoplastic resin that melts at 200° C. or lower) contained in the molding material melts and the thermosetting polyurethane particles do not melt. This can provide a method for producing a molded article that can produce a molded article that contains polyurethane and has excellent mechanical strength, particularly, both impact strength and bending strength. In addition, the bending modulus of the produced molded article can also be made excellent.

As the molding method, for example, compression molding, extrusion molding, or the like may be employed, but injection molding is preferable. This can suitably produce even a molded article having a complicated structure, a molded article having a fine structure, or the like.

The heating temperature of the molding material in the molding step is preferably 160° C. or higher and 200° C. or lower, and more preferably 170° C. or more and 190° C. or lower. This can make the moldability and the productivity of the molded article more excellent while more suitably preventing the thermal decomposition of the polyurethane. In addition, the mechanical strength of the produced molded article can be made more excellent.

The method for producing a molded article of the present disclosure may further include steps other than the molding step. For example, after the molding step, a post-treatment step of performing machining such as grinding and polishing or post-treatment such as coating and plating may be included.

As described above, the method for producing a molded article of the present disclosure is only required to include a molding step of molding the above-described molding material of the present disclosure while heating to a temperature at which the thermoplastic resin (that is, the thermoplastic resin that melts at 200° C. or lower) contained in the molding material melts and the thermosetting polyurethane particles do not melt, but preferably includes a heating and kneading step of kneading organic fibers that do not melt at 200° C., a thermoplastic resin that melts at 200° C. or lower, and thermosetting polyurethane particles while heating such that the thermoplastic resin melts and the thermosetting polyurethane particles do not melt to obtain a molding material containing the organic fibers, the thermoplastic resin, and the thermosetting polyurethane particles, and a molding step of molding the molding material while heating to a temperature at which the thermoplastic resin melts and the thermosetting polyurethane particles do not melt, in which the content of the thermosetting polyurethane particles in the molding material is 10.0% by mass or more and 40.0% by mass or less, the content of the thermoplastic resin in the molding material is 20.0% by mass or more and 75.0% by mass or less, the content of the organic fibers in the molding material is 10.0% by mass or more and 55.0% by mass or less, the organic fibers are at least one kind selected from the group consisting of cellulose fibers and fibers made of a thermoplastic resin, the organic fibers are a defibrated product of a fabric, the heating temperature in the heating and kneading step is 150° C. or higher and 200° C. or lower, and the heating temperature in the molding step is 160° C. or higher and 200° C. or lower. This allows each of the above-described effects to work synergistically with each other, resulting in a particularly excellent effect.

Although the preferred embodiments of the present disclosure have been described above, the present disclosure should not be limited to the embodiments.

For example, the molding material of the present disclosure is only required to contain the organic fibers that do not melt at 200° C., the thermoplastic resin that melts at 200° C. or lower, and the thermosetting polyurethane particles, and is not limited to the one produced by the method as described above.

In addition, the molded article of the present disclosure is only required to be formed of the molding material of the present disclosure, and is not limited to the one produced by the method as described above.

### EXAMPLES

Next, specific examples of the present disclosure will be described.

### [5] Preparation of Raw Materials of Molding Material

First, wastepaper containing cellulose fibers, collected articles of clothes on the market containing rayon, collected articles of clothes on the market containing acrylic fibers, collected articles of clothes on the market containing polyester fibers, a waste cushioning material containing a thermosetting urethane foam, and a Multi Polymax belt manufactured by Mitsuboshi Belting Ltd. as a thermosetting urethane rubber are prepared.

Next, each of the wastepaper and the collected articles of clothes on the market is shredded into a substantially cubic shape a few millimeters square by using a shredder having a coarsely crushing blade in the air, and then an air current is blown to the shreds to defibrate it. This produces pulp-defibrated cotton, and rayon and acrylic fibers as the organic fibers that do not melt at 200° C.

On the other hand, the waste cushioning material containing a thermosetting urethane foam and the thermosetting urethane rubber are crushed into a predetermined size by performing a crushing process using a crusher having an inner blade and an outer blade. This produces a thermosetting urethane foam and a thermosetting urethane rubber as the thermosetting polyurethane particles.

As the thermoplastic resins that melts at 200° C. or lower, a commercially available polypropylene (manufactured by Prime Polymer Co., Ltd., H700) and a commercially available thermoplastic polyurethane (manufactured by Nisshinbo Textile Inc., Mobilon Tape MW-1003T) are prepared. The melting point of the polypropylene is 165° C. The melting point of the thermoplastic polyurethane is 150° C.

### [6] Preparation of Molding Material

### Example 1

A heating and kneading step is performed in which the pulp-defibrated cotton as the organic fibers that do not melt at 200° C., the polypropylene as the thermoplastic resin that melts at 200° C. or lower, and the thermosetting urethane foam as the thermosetting polyurethane particles are put into a biaxial kneader (manufactured by Technovel Corporation, KZW15TW-45MG) at a predetermined ratio and kneaded. The kneading conditions include a maximum heating temperature of 170° C. and an extrusion discharge amount of 1 kg/hr. Next, the kneaded product is processed into a strand shape, and then made into a pellet-shaped molding material with a pelletizer. The obtained molding material has a structure in which the organic fibers that do not melt at 200° C. and the thermosetting polyurethane particles are dispersed in the thermoplastic resin that melts at 200° C. or lower. The average length of the cellulose fibers as the organic fibers that do not melt at 200° C. contained in the molding material is 700 μm, the average diameter of the cellulose fibers as the organic fibers that do not melt at 200° C. is 15 μm, and the average particle size of the thermosetting polyurethane particles is 2.0 mm.

### Examples 2 to 8

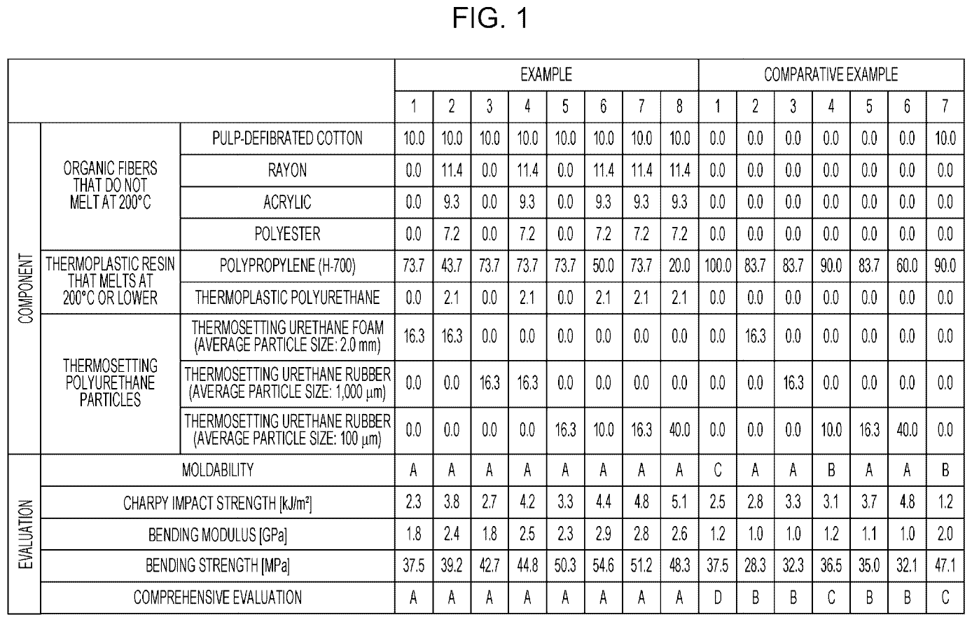

Pellet-shaped molding materials are prepared in the same manner as in Example 1 above except that the kinds and the amounts of use of the raw materials are changed such that the compositions of the molding materials are as shown in FIG. 1.

In the molding material of each of Examples above, the organic fibers that do not melt at 200° C. have an average length of a value in a range of 100 μm or more and less than 400 μm, an average diameter of a value in a range of 5 μm or more and less than 20 μm, and an average aspect ratio of a value in a range of 15 or more and 100 or less, and maintain a fibrous shape. The average particle size of the thermosetting polyurethane particles contained in the molding material of each of Examples above is a value in a range of 1.0 μm or more and 2.0 mm or less.

### Comparative Examples 1 to 7

Pellet-shaped molding materials are prepared in the same manner as in Example 1 above except that the kinds and the amounts of use of the raw materials are changed such that the compositions of the molding materials are as shown in FIG. 1.

### [7] Production of Molded Article

The molding material of each of Examples and Comparative Examples above is injection molded using an injection molding machine (manufactured by Nissei Plastic Industrial Co., Ltd., THX40-5 V), a molded article for evaluation of Charpy impact strength, a molded article for evaluation of bending strength, and a molded article for evaluation of bending modulus, which will be described later, are attempted to be produced. The heating temperature of the molding material at the time of injection molding is 170° C. The molded article for evaluation of Charpy impact strength is a rectangular plate-shaped molded article having long a long side of 80 mm±2 mm, a short side of 4.0 mm±0. 2 mm, and a thickness of 10.0 mm±0.2 mm, and the molded article for evaluation of bending strength and the molded article for evaluation of bending modulus are rectangular plate-shaped molded articles having a long side of 80 mm±2 mm, a short side of 10.0 mm±0.2 mm, and a thickness of 4.0 mm±0.2 mm.

### [8] Evaluation

The molded article according to each of Examples and Comparative Examples above is evaluated as follows.

### [8-1] Moldability

For each of Examples and Comparative Examples above, 10 molded articles for evaluation of bending strength attempted to be produced as described in [7] above are evaluated in accordance with the following criteria. Note that a molded article satisfying the conditions that no drooling (nose running) occurs in the injection molding machine and there is no flash, short shot, void, sink mark, silver streak, flow mark, warping, weld line, crack, jetting, or burn in the molded article is regarded as a non-defective article, and a molded article not satisfying the conditions is regarded as a defective article.
A: The number of non-defective articles is 10 out of 10.
B: The number of non-defective articles is 6 or more and 9 or less out of 10.
C: The number of non-defective articles is 1 or more and 5 or less out of 10.
D: The number of non-defective articles is 0 out of 10.

### [8-2] Charpy Impact Strength

The Charpy impact strength of the molded article for evaluation of Charpy impact strength according to each of Examples and Comparative Examples above produced as described in [7] above is measured in accordance with ISO 179 (JIS K7111) using Impact Tester IT manufactured by Toyo Seiki Seisaku-sho, Ltd. In the measurement of Charpy impact strength, the hammer weight is 4 J (WR: 2.14 N/m), the lifting angle is 150°, the notch residual width is 8.0 mm±0.2 mm, and the notch angle is 45°.

### [8-3] Bending Modulus

The bending modulus of the molded article for evaluation of bending modulus according to each of Examples and Comparative Examples above produced as described in [7] above is measured in accordance with ISO 178 (JIS K7171) using 68TM-30 manufactured by Instron Co., Ltd. In the measurement of bending modulus, the distance between fulcrums is set to 64 mm.

### [8-4] Bending Strength

The bending strength of the molded article for evaluation of bending strength according to each of Examples and Comparative Examples above produced as described in [7] above is measured in accordance with ISO 178 (JIS K7171) using 68TM-30 manufactured by Instron Co., Ltd. In the measurement of bending strength, the distance between fulcrums is set to 64 mm.

### [8-5] Comprehensive Evaluation

From the results of [8-1] to [8-3] above, each of Examples and Comparative Examples above is comprehensively evaluated in accordance with the following criteria.
A: The evaluation of [8-1] above is A, the evaluation of [8-2] above is 2.3 kJ/m² or more, and the evaluation of above is 1.5 GPa or more.
B: The evaluation of [8-1] above is A, and the evaluation of [8-2] above is less than 2.3 kJ/m² or the evaluation of [8-3] above is less than 1.5 GPa.
C: The evaluation of [8-1] above is B.
D: The evaluation of [8-1] above is C.

These results are collectively shown in FIG. 1 together with the compositions of the molding materials obtained in Examples and Comparative Examples above.

In FIG. 1, the numerical values of the components indicate the content in the molding material, and the unit thereof is % by mass. A polypropylene (manufactured by Prime Polymer Co., Ltd., H-700, melting point: 165° C.) is indicated as “POLYPROPYLENE,” and a thermoplastic polyurethane (manufactured by Nisshinbo Textile Inc., Mobilon Tape MW-1003T, melting point: 150° C.) is indicated as “THERMOPLASTIC POLYURETHANE.” In the molded article of each of Examples above, the organic fibers that do not melt at 200° C. have an average length of a value in a range of 100 μm or more and less than 400 μm, an average diameter of a value in a range of 5 μm or more and less than 20 μm, and an average aspect ratio of a value in a range of 15 or more and 100 or less, and maintain a fibrous shape. The average particle size of the thermosetting polyurethane particles contained in the molded article of each of Examples above is a value in a range of 1.0 μm or more and 2.0 mm or less, and the number average molecular weight of the thermosetting polyurethane contained in the molding material of each of Examples above is a value in a range of 40,000 or more and 150,000 or less.

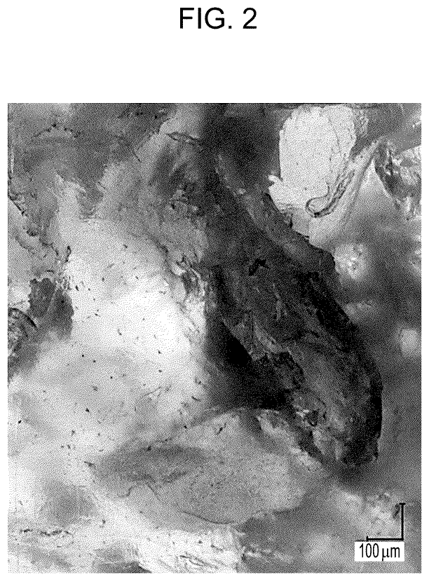

FIG. 2 is a photograph showing an image obtained by performing transmitted illumination observation using a digital microscope for a sample obtained by slicing the molded article used for evaluation of Charpy impact strength of Comparative Example 3 into a thickness of 100 μm. As the digital microscope, a digital microscope VHX-5000 manufactured by Keyence Corporation is used.

As is clear from FIG. 1, excellent results are obtained in each of Examples above. On the other hand, in each of Comparative Examples above, no satisfactory results are obtained. As shown in FIG. 2, the molded article of Comparative Example 3 has a structure in which the organic fibers that do not melt at 200° C. and the thermosetting polyurethane particles are dispersed in the thermoplastic resin that melts at 200° C. or lower. The molded articles of the other Examples also have a similar structure.

Molding materials are produced in the same manner as in each of Examples above except for variously changing the content of the organic fibers that do not melt at 200° C. in a range of 10.0% by mass or more and 55.0% by mass or less, the content of the thermosetting polyurethane particles in a range of 10.0% by mass or more and 40.0% by mass or less, and the content of the thermoplastic resin in a range of 20.0% by mass or more and 75.0% by mass or less in the molding material, variously changing the average length of the organic fibers that do not melt at 200° C. contained in the molding material in a range of 50 μm or more and less than 3 mm, the average diameter of the organic fibers that do not melt at 200° C. in a range of 3 μm or more and less than 100 μm, the average aspect ratio of the organic fibers that do not melt at 200° C. in a range of 10 or more and 1,000 or less, the average particle size of the thermosetting polyurethane particles in a range of 100 μm or more and 2 mm or less, the number average molecular weight of the thermosetting polyurethane in a range of 20,000 or more and 300,000 or less, and variously changing the heating temperature in the heating and kneading step in a range of 150° C. or higher and 200° C. or lower, and when the same evaluations as those described above are performed on these molding materials, results similar to those described above are obtained. For each of Examples above, molded articles are produced in the same manner as described above except for variously changing the heating temperature in the molding step of producing the molded article in a range of 160° C. or higher and 200° C. or lower, and when the same evaluations as those described above are performed on these molded articles, results similar to those described above are obtained.

What is claimed is:

1. A molding material comprising:
organic fibers that do not melt at 200°C;
a thermoplastic resin that melts at 200°C or lower; and
thermosetting polyurethane particles.

2. The molding material according to claim 1, wherein a content of the thermosetting polyurethane particles is 10.0% by mass or more and 40.0% by mass or less.

3. The molding material according to claim 1, wherein a content of the thermoplastic resin is 20.0% by mass or more and 75.0% by mass or less.

4. The molding material according to claim 1, wherein a content of the organic fibers is 10.0% by mass or more and 55.0% by mass or less.

5. The molding material according to claim 1, wherein an average particle size of the thermosetting polyurethane particles is 2.0 mm or less.

6. The molding material according to claim 1, wherein the organic fibers are at least one kind selected from the group consisting of cellulose fibers and fibers made of a thermoplastic resin.

7. The molding material according to claim 1, wherein the organic fibers are a defibrated product of a fabric.

8. A method for producing a molding material, the method comprising a heating and kneading step of kneading organic fibers that do not melt at 200°C, a thermoplastic resin that melts at 200°C or lower, and thermosetting polyurethane particles while heating such that the thermoplastic resin melts and the thermosetting polyurethane particles do not melt.

9. The method for producing a molding material according to claim 8, wherein a heating temperature in the heating and kneading step is 150° C. or higher and 200° C. or lower.

10. A molded article comprising the molding material according to claim 1.

11. A method for producing a molded article, the method comprising a molding step of molding the molding material according to claim 1 while heating to a temperature at which the thermoplastic resin melts and the thermosetting polyurethane particles do not melt.

12. The method for producing a molded article according to claim 11, wherein a heating temperature in the molding step is 160° C. or higher and 200° C. or lower.

13. A method for producing a molded article, the method comprising:
a heating and kneading step of kneading organic fibers that do not melt at 200°C, a thermoplastic resin that melts at 200°C or lower, and thermosetting polyurethane particles while heating such that the thermoplastic resin melts and the thermosetting polyurethane particles do not melt to obtain a molding material containing the organic fibers, the thermoplastic resin, and the thermosetting polyurethane particles; and
a molding step of molding the molding material while heating to a temperature at which the thermoplastic resin melts and the thermosetting polyurethane particles do not melt, wherein
a content of the thermosetting polyurethane particles in the molding material is 10.0% by mass or more and 40.0% by mass or less,
a content of the thermoplastic resin in the molding material is 20.0% by mass or more and 75.0% by mass or less,
a content of the organic fibers in the molding material is 10.0% by mass or more and 55.0% by mass or less,
the organic fibers are at least one kind selected from the group consisting of cellulose fibers and fibers made of a thermoplastic resin,
the organic fibers are a defibrated product of a fabric,
a heating temperature in the heating and kneading step is 150° C. or higher and 200° C. or lower, and
a heating temperature in the molding step is 160° C. or higher and 200° C. or lower.
